(19) United States
(12) Patent Application Publication
(10) Pub. No.: US 2013/0125005 A1
(43) Pub. Date: May 16, 2013

(54) CONTEXTUAL DATA DISPLAYED VIA BROWSER TOOLBAR

(71) Applicants: CHARLES HASTINGS FRENCH, SEATTLE, WA (US); TIMOTHY MATTHEW EDGAR, BELLEVUE, WA (US); IGOR AVRAMOVIC, BELLEVUE, WA (US); SUNIL PANDEY, SEATTLE, WA (US)

(72) Inventors: CHARLES HASTINGS FRENCH, SEATTLE, WA (US); TIMOTHY MATTHEW EDGAR, BELLEVUE, WA (US); IGOR AVRAMOVIC, BELLEVUE, WA (US); SUNIL PANDEY, SEATTLE, WA (US)

(73) Assignee: MICROSOFT CORPORATION, REDMOND, WA (US)

(21) Appl. No.: 13/295,872

(22) Filed: Nov. 14, 2011

(51) Int. Cl. G06F 3/048

(52) U.S. Cl. 715/738

(57) ABSTRACT

A browser toolbar displays contextual data from a search engine service for a webpage currently being displayed by a web browser. The browser toolbar identifies the URL of a webpage currently being displayed by a web browser. The browser toolbar provides an indication of the URL to a search engine service, which identifies an entity corresponding with the URL. The search engine service gathers data relevant to the entity and provides the relevant data to the browser toolbar, which displays information to the user to provide the user with contextual information about the entity corresponding with the URL.

### BACKGROUND

Currently, Internet users surf the web with only their knowledge of what exists. When they visit a webpage, they may not realize or may not easily be able to access additional information regarding the webpage or the content of the webpage. For instance, if a user is viewing a webpage regarding a certain restaurant, the webpage may have only limited information about the restaurant such that the user may want to find more information (e.g., directions, menu information, how to make reservations, etc.). The user may use a search engine to try to search for additional information for the restaurant. However, there may be a large number of search results returned with different pieces of information. It may then be time consuming for the user to sift through the search results to find relevant information. Additionally, the user may miss important information and make uninformed or misinformed decisions.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to using a browser toolbar to provide contextual information from a search engine service about an entity corresponding with a webpage currently being viewed by a user. When a user visits a webpage, the browser toolbar identifies the URL of the webpage and passes the webpage to a search engine service. The search engine service identifies an entity corresponding with the webpage, gathers data about the entity, and returns the data to the browser toolbar. The browser toolbar then presents returned data to provide the user with contextual information corresponding with the webpage being viewed. The information may include a number of actions that a user can perform by selecting the actions to navigate to other webpages to perform the actions. The contextual information may be persistently displayed by the browser toolbar while the user navigates to the other webpages to perform the actions.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a screenshot showing contextual data displayed by a browser toolbar in accordance with an embodiment of the present invention;

FIG. 3 is a block diagram showing a system for providing search results to name search queries in accordance with an embodiment of the present invention;

FIG. 4 is a flow diagram showing a method for a browser toolbar to access, from a search engine service, contextual data regarding an entity corresponding with a currently viewed webpage in accordance with an embodiment of the present invention; and

FIG. 5 is a flow diagram showing a method for a browser toolbar to display data in a contextual display area in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are generally directed to using a browser toolbar to provide contextual information regarding a webpage currently being viewed by a user. The contextual information is accessed from a search engine service. In embodiments, the browser toolbar identifies the URL of a webpage currently being viewed by a user via a web browser in which the browser toolbar is installed. The browser toolbar may also track session data including the URLs of other webpages visited during the current browsing session. The browser toolbar provides an indication of the URL of the webpage currently being viewed and the session data to a search engine service. The search engine service identifies an entity corresponding with the webpage being viewed based on the URL of the webpage and/or the session data. The search engine service also gathers relevant data regarding the entity and returns the relevant data to the browser toolbar, which presents the relevant data to provide contextual information regarding the entity.

Accordingly, in one aspect, an embodiment of the invention is directed to a method for a search engine service to provide contextual information to a browser toolbar. The method includes receiving, from the browser toolbar on a user device, an indication of a URL of a webpage currently being viewed by a user of the user device. The method also includes determining an entity corresponding with the URL and gathering relevant data regarding the entity from a search engine index. The method further includes providing the relevant data regarding the entity to the browser toolbar on the user device for presenting at least a portion of the relevant data on the user device via the browser toolbar.

In another embodiment, an aspect of the invention is directed to one or more computer storage media storing computer-useable instructions that, when used by one or more computing devices, cause the one or more computing devices to perform a method for presenting contextual data using a browser toolbar. The method includes identifying a URL of a webpage currently being viewed by a user in a web browser. The method also includes providing an indication of the URL to a search engine service that identifies an entity corresponding with the URL and retrieves data regarding the entity. The method further includes receiving the data regarding the entity from the search engine service. The method also includes providing a contextual display area to display at least a portion of the data regarding the entity to the user, including a plurality of actions that include links to other webpages to perform the actions. The method further includes receiving a user selection of a first link corresponding with a first action. The method still further includes continuing to display the contextual display area when the web browser navigates to a webpage corresponding with the first link.

A further embodiment is directed to one or more computer storage media storing a browser toolbar usable in web browser. The browser toolbar includes a session tracking component that identifies URLs of webpages visited by a user during a current browsing session. The browser toolbar also includes a search engine interface that communicates to a search engine service an identification of a URL of a webpage currently being displayed in the web browser and session data that identifies URLs of other webpages visited during the current browsing session, the search engine interface also receiving in return from the search engine relevant data regarding an entity corresponding with the webpage currently being displayed in the web browser. The browser toolbar further includes a contextual data display component the displays at least a portion of the relevant data.

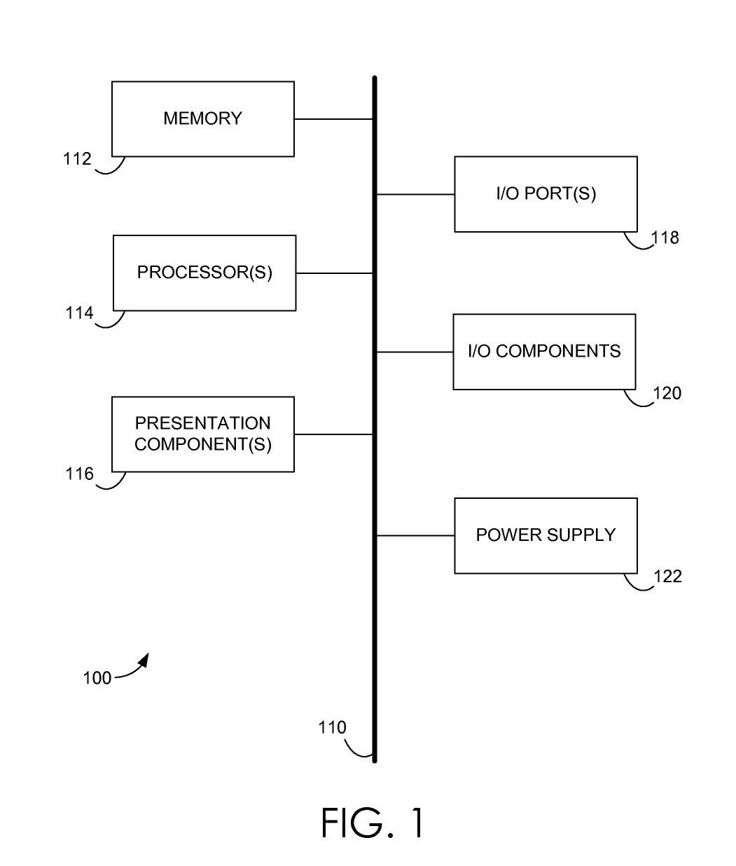

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

As previously discussed, embodiments of the present invention are generally directed to a browser toolbar having the ability to understand the user's context and provide the user with contextual information from a search engine service that may provide more information than can be found on the webpage being viewed. When a user visits a webpage, the browser toolbar may identify the URL of the webpage and pass the URL to a search engine service. The browser toolbar may also maintain browser session data, which includes an indication of URLs of other webpages visited by the user during the current browsing session, and the browser toolbar may also provide the session data to the search engine service. The search engine service may analyze the URL of the currently viewed webpage and/or the session data to identify an entity corresponding with URL. The search engine service may then gather data relevant to the identified entity and return the data to the browser toolbar, which may present data to the user in a meaningful user interface.

The data gathered by the search engine service and provided to the browser toolbar may be any data available to the search engine service. Generally, search engine services operate by crawling electronic documents and indexing information regarding the crawled documents in a search engine index that is traditionally used in identifying search results to search queries issued to the search engine services. As such, the search engine service may store and be able to provide consolidated information regarding an entity extracted from multiple sources. The data provided to the browser toolbar by the search engine service does not have to be present on the web page being viewed or linked to on the web page.

As used herein, the term “browser toolbar” refers to any type of extension that is not native to a web browser but instead is an extension to the web browser to provide search capabilities and further functionality. For instance, a user may download and install a search provider's toolbar, which is then presented as part of the web browser. The toolbar may include, for example, tabs for aiding a user in navigating the web and in organizing display space. A toolbar may additionally or alternatively include one or more shortcut buttons that provide ease of access to commonly used functions and/or one or more of a multitude of web browser add-on components that are available in the art. In one embodiment, a toolbar is a search toolbar that provides a search interface. For instance, a search toolbar may reside near a web browser tab bar and provide a search box to carry out web searches.

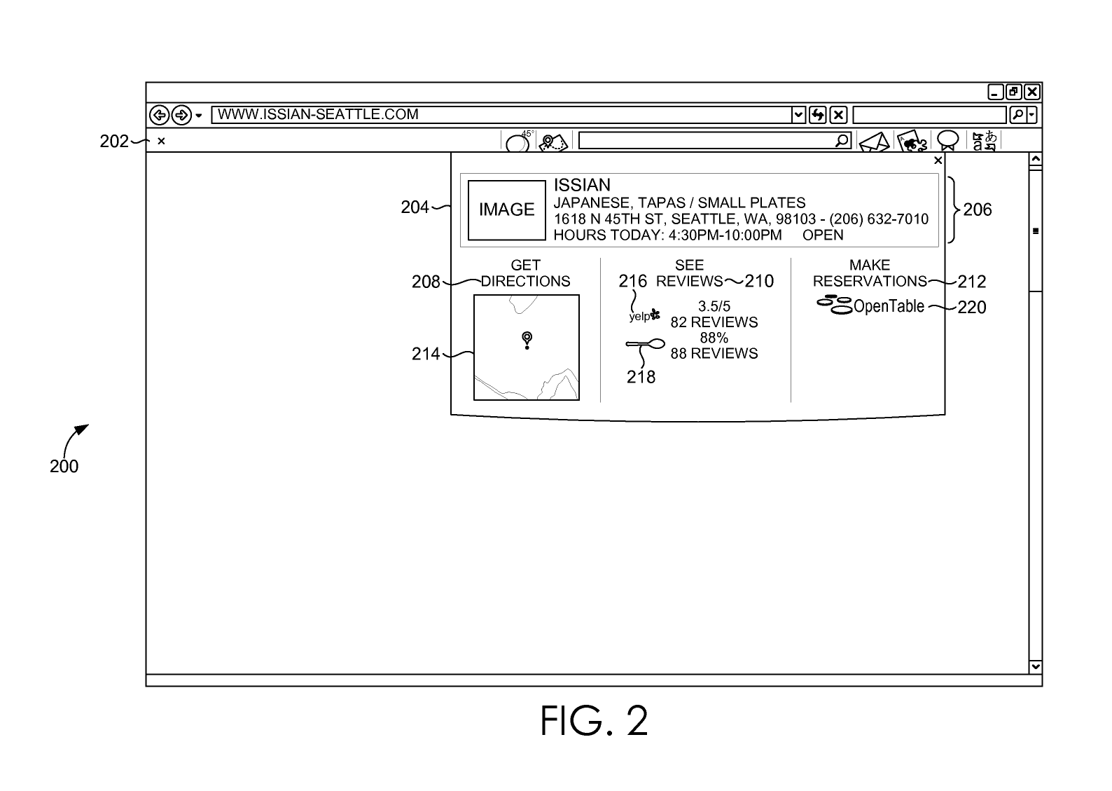

By way of illustration of an embodiment of the present invention, FIG. 2 shows a screenshot of a web browser 200 with a browser toolbar 202. As shown in FIG. 2, the user has navigated to a webpage (shown as blank for clarity purposes) corresponding with a particular restaurant (Issian). In accordance with embodiments of the present invention, the browser toolbar may identify the URL of the currently visited webpage and pass that URL to a search engine service. The search engine service identifies the particular restaurant as the entity corresponding with that URL, gathers data regarding the restaurant, and returns the data to the browser toolbar. The browser toolbar presents a contextual display area 204 with data returned by the search engine service. The data displayed in the contextual display area 204 includes general information 206 about the restaurant (e.g., name, food type, address, phone number, hours, etc.). Additionally, the data display may include actions or steps to complete a task. In FIG. 2, the actions displayed include: get directions 208, see reviews 210, and make reservations 212.

The displayed data may include links to different webpages. For instance, the get directions action 208 includes a map image 214 that links to a map with directions to the restaurant. The see reviews action 210 includes a link 216 to reviews for the restaurant on the YELP website and a link 218 to reviews for the restaurant on the URBANSPOON website. Further, the make reservations action includes a link 220 to the OPENTABLE reservation system to allow the user to make a reservation at the restaurant. If the user selects one of the links, the web browser 200 may navigate to a new webpage. However, the contextual display area 204 may be persistently displayed by the browser toolbar to allow the user to continue to view the data while the user navigates to different webpages to perform different actions associated with the restaurant. For instance, if the user were to select the link 216, a webpage from the YELP website with reviews for the restaurant would be displayed in the web browser 200. However, the contextual display area 204 would continue to be displayed to allow the user to continue to view the information regarding the restaurant and make further selections. For example, after reading the reviews, the user may decide to make a reservation and select the link 220 to make reservations using the OPENTABLE reservation system.

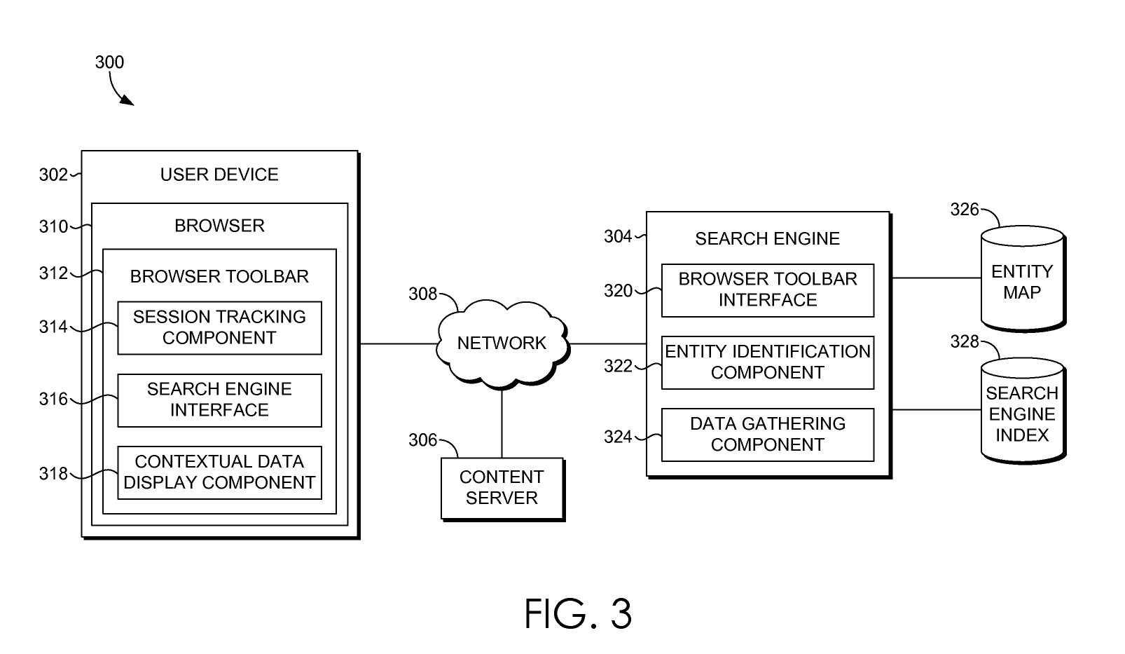

Referring now to FIG. 3, a block diagram is provided illustrating an exemplary system 300 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 300 may include a user device 302, a search engine 304, and a content server 306. Each of the components shown in FIG. 3 may be embodied on any type of computing device, such as computing device 100 described with reference to FIG. 1, for example. The components may communicate with each other via a network 308, which may include, without limitation, one or more local area networks (LANs) and/or wide area networks (WANs). Such networking environments are commonplace in offices, enterprise-wide computer networks, intranets, and the Internet. It should be understood that any number of user devices, search engines, and content servers may be employed within the system 300 within the scope of the present invention. Each may comprise a single device or multiple devices cooperating in a distributed environment. For instance, the search engine 304 may comprise multiple devices arranged in a distributed environment that collectively provide the functionality described herein. Additionally, other components not shown may also be included within the system 300.

In accordance with embodiments of the present invention, a browser toolbar 312 installed in the web browser 310 operates to provide contextual data from the search engine 304 as the user navigates web pages. As shown in FIG. 3, the browser toolbar 312 includes, among other things, a session tracking component 314, a search engine interface 316, and a contextual data display component 318.

Generally, a user may employ the web browser 310 on the user device 302 to access webpages and other electronic documents from content servers, such as the content server 306, via the network 308. As the user navigates to different webpages, the session tracking component 314 tracks the URLs of web pages visited during the browsing session. When a user navigates to a webpage, the session tracking component 314 may identify the URL of the webpage currently being viewed in the web browser 310. The URL of the webpage currently being viewed and session data from the current browsing session (e.g., the URLs of other webpages visited) is communicated to the search engine 304 via the search engine interface 316 over the network 308. The URL of the webpage currently being viewed and the session data from the current browsing session may be communicated to the search engine 304 at the same time or at different times in various embodiments of the invention.

The search engine 304 includes a browser toolbar interface 320 operable to communicate with the browser toolbar 312. The browser toolbar interface 320 receives the URL of the webpage currently being viewed on the user device 302 and the session data from the current browsing session. Using the URL and/or the session data, an entity identification component 322 attempts to identify an entity corresponding with the URL. An entity may be identified for a URL in a variety of different manners within the scope of embodiments of the present invention. In some embodiments, the search engine 304 may maintain an entity map 326 that maps entities to URLs, and identification of an entity may include looking up the URL in the entity map 326 and identifying the entity associated with the URL in the entity map 326. For instance, in the example in which a user is viewing a webpage for a particular restaurant, the entity map 326 may identify that particular restaurant as corresponding with the URL. In some embodiments, the search engine 304 may have analyzed data available to it (e.g., information indexed in the search engine index) to identify entities associated with various URLs. This analysis may look at a number of different sources, including some sources that may be considered authoritative for certain types of entities (e.g., the YELP website for restaurants).

An entity may also be identified by parsing the text of the URL. For instance, the text of the URL may contain the name of the restaurant. An entity may also be identified by analyzing information indexed about the URL in the search engine index 328. As is known in the art, the search engine index 328 may index information obtained by crawling webpages and other electronic documents. Typically, the search engine index 328 is used by the search engine to return search results to search queries issued to the search engine 304. The entity identification component may leverage the information in the search engine index 328 to identify an entity associated with the URL.

The entity identification component 322 may also use the session data from the user's current browsing session to identify an entity for the webpage currently being viewed. For instance, an entity may not be identified with a sufficient level of confidence based on just the URL of the webpage currently being viewed. As such, information regarding other webpages the user has visited during the current browsing session may help to identify an entity. For instance, if the user has looked at a number of webpages regarding a particular restaurant, that information may be useful to identify the restaurant as the entity for the webpage currently being viewed with a greater level of confidence. Generally, the URLs for the other webpages viewed during the current browsing session may be used to identify an entity in similar manners as discussed above, such as looking up the URLs in the entity map 326, analyzing the text of the URLs, and analyzing information indexed for the URLs in the search engine index 328.

After an entity has been identified, a data gathering component 324 operates to gather relevant information for the entity. The information may be accessed from the search engine index 328 or other data source available to the search engine 304. In some embodiments, the type of data gathered may be dependent on the type of entity identified. For instance, if a particular restaurant is identified as the entity for a webpage, the information gathered would be dependent upon the entity type being a restaurant. Relevant information for a restaurant may include directions, food type, pricing, reviews, and reservations. This information is relevant to restaurants. Other types of entities may cause data to get gathered that is relevant to each of those types of entities.

The relevant data that is gathered by the search engine 304 is returned to the browser toolbar 312. A contextual data display component 318 operates to display the relevant data to the user. As such, the browser toolbar 312 presents data relevant to the webpage currently being viewed. The contextual data display component 318 may simply display all data returned to the browser toolbar 312. Alternatively, the contextual data display component 318 may heuristically determine the most relevant information to present to the user. Because it is preferred to display data when the user is interacting with a webpage or the browser, in some embodiments, the browser toolbar 312 may determine how interactive the user is with the browsing session and may have certain conditions that have to be met before the information is shown to the user. This may increase the effectiveness of displaying the information.

In some embodiments, each of the various pieces of data returned to the browser toolbar 312 may have confidence metrics associated with it. The contextual data display component may have the ability to select pieces of data to display based on the confidence metrics being above some threshold, which may be based on the level of engagement of the user (e.g., the more interactive the user is, the more information is shown).

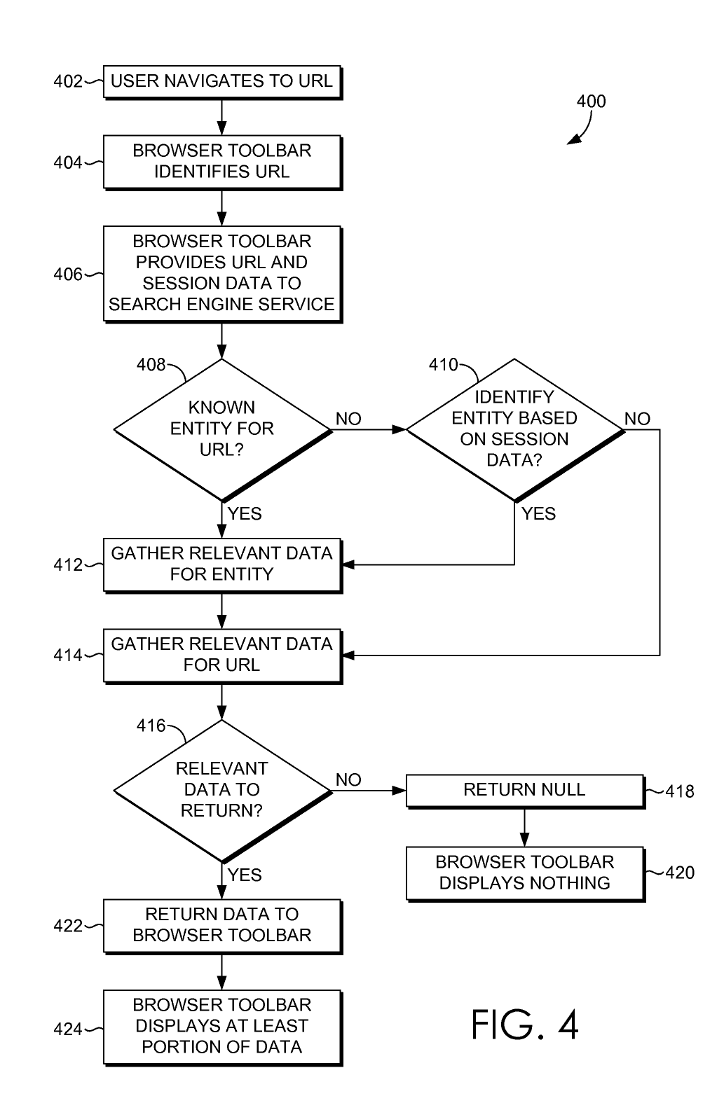

Referring now to FIG. 4, a flow diagram is provided that illustrates a method 400 for a browser toolbar to access, from a search engine service, contextual data regarding an entity corresponding with a currently viewed webpage in accordance with an embodiment of the present invention. As shown at block 402, a user navigates to a particular URL using a web browser on a user device, such as a desktop computer, laptop computer, tablet computer, or mobile device. In response to the user navigating to the URL, a browser toolbar installed in the web browser identifies the URL, as shown at block 404. The browser toolbar passes the URL to a search engine service, as shown at block 406. In some embodiments, in addition to passing the URL to which the user has currently navigated, the browser toolbar may collect browser session data and pass the browser session data to the search engine service. The browser session data may include information regarding other URLs the user has visited during the current browsing session. In some embodiments, collecting and passing the URL and session data to the search engine service does not require the browser toolbar to scrape and parse the webpage corresponding with the visited URLs. Instead, the browser toolbar may simply perform some basic monitoring of the user's interaction with a visited webpage but does not need to take any actions to inform the user. Instead, the URL and session data may be passed to the search engine service to leverage the power of the cloud and also to reduce use of the user device's local resources.

When the search engine service receives the URL from the browser toolbar, the search engine service determines if there is a known entity associated with the URL, as shown at block 408. In some embodiments, the search engine service may maintain data mapping URLs to particular entities. The mapping data may have been created manually or algorithmically by analyzing data from webpages collected by the search engine service or an associated service by crawling the webpages. If mapping data is available, the search engine service may access the mapping data to determine if an entity has been identified for the URL already. If mapping data is not available, the search engine service may attempt to identify an entity by analyzing data regarding the URL that was collected by the search engine service or associated service by crawling webpages. For instance, this may include data collected by crawling webpages and indexed in a search engine index to facilitate returning search results to search queries.

If an entity cannot be determined with a certain level of certainty based on the URL alone, the search engine service attempts to identify an entity using the session data as well, as shown at block 410. Because the session data includes other URLs the user has visited in the same session, the search engine service may be able to determine whether a particular entity may be identified based on those URLs. For instance, if session data indicates that the user has visited a number of webpages directed to a particular restaurant, the search engine service may be able to identify the restaurant as the entity based on the URLs for those webpages.

If an entity is identified based on the URL and/or the session data, relevant data for the entity is retrieved by the search engine service, as shown at block 412. The data may be retrieved from a search engine index or other data store that may store information on a per-entity basis. By way of example, if the entity is a particular restaurant, the relevant data stored by the search engine index for the restaurant may include reviews and ratings aggregated from various other websites, reservation options, directions to the restaurant, price and menu information, images, and videos.

Relevant data for the URL may also be retrieved from the search engine index, as shown at block 414. In particular, the search engine service may access data regarding the URL from the search engine index or other data store. This may be in addition to relevant data for an identified entity. In the case that no entity is identified, only data for the URL would be retrieved.

As shown at block 416, the search engine service determines if there is relevant data to return to the browser toolbar. In some cases, no relevant data for an entity and/or URL may be identified, the search engine service returns null to the browser toolbar at block 418, and the browser toolbar displays nothing, as shown at block 420. However, if relevant data is identified by the search engine service, the search engine service returns the data to the browser toolbar, as shown at block 422.

The browser toolbar displays at least some of the returned data to the user, as shown at block 424. In some embodiments, the browser toolbar may simply display all the data returned by the search engine service. In other embodiments, the browser toolbar may analyze the data and/or user interactions to determine what data to display and when to display the data. In some embodiments, based on previously collected data for the user and the current data for the webpage, the browser toolbar may heuristically determine the most relevant information to present to the user. The data may contain classification types for all the contextual information received from the search engine service, and the browser toolbar may select different contextual information or tasks to present based on the classification types.

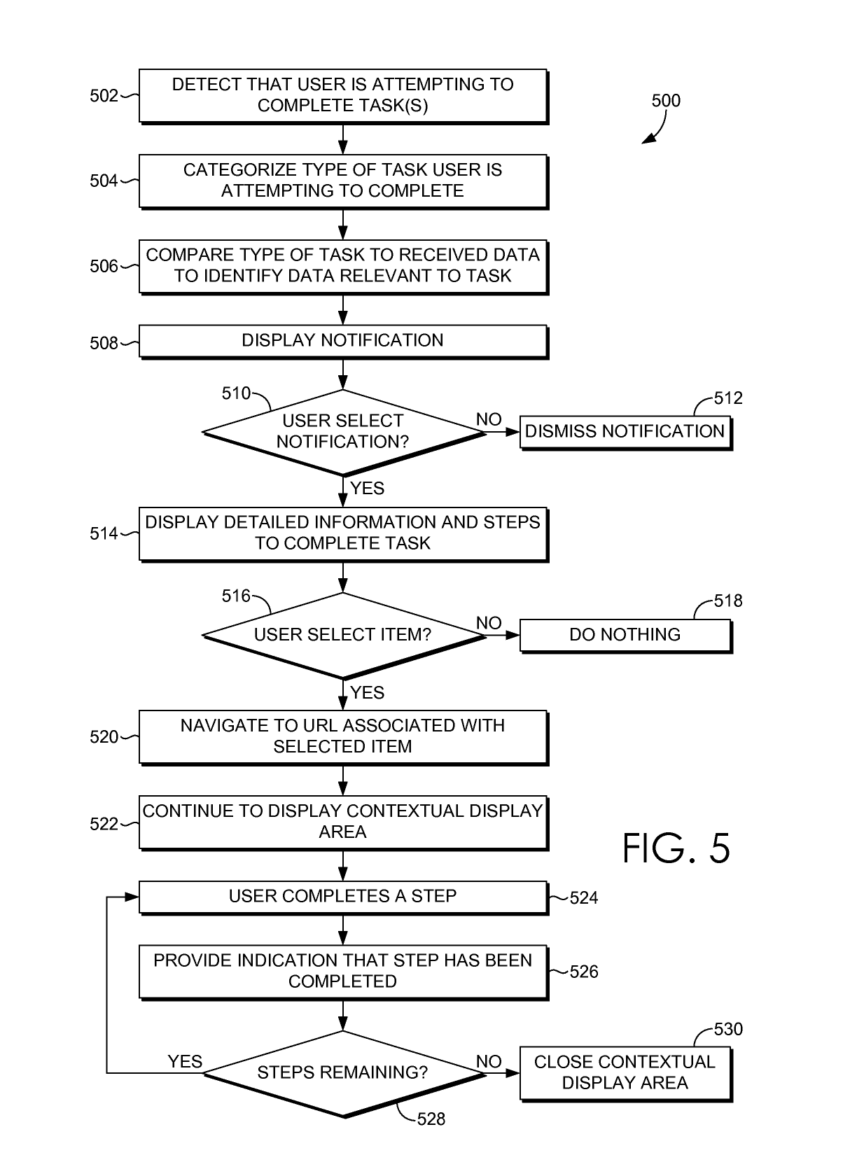

In some embodiments, the browser toolbar may attempt to identify a task (or multiple tasks) a user is completing and presents relevant data from the search engine service that will assist the user in completing the task(s). Referring now to FIG. 5, a flow diagram is provided that illustrates a method 500 for a browser toolbar to display data in a contextual display area in accordance with an embodiment of the present invention.

As shown at block 502, the browser toolbar detects that the user is attempting to complete a task (or multiple tasks) on the webpage. The browser toolbar categorizes the type of task the user is attempting to complete, as shown at block 504. The browser toolbar then compares the type of task to the data received from the search engine service to identify data relevant to the type of task, as shown at block 506. This may include the browser toolbar dissecting data relevant to the task and preparing the dissected data to be shown to the user. As an example, suppose that the user is looking at a webpage associated with a particular restaurant and that the browser toolbar detects user activity on sub pages for the webpage and determines that the user is seeking additional information about the restaurant. Based on this, the browser toolbar may select restaurant review data, directions, and reservation information to present to the user.

The browser toolbar uses the dissected data and displays a notification with the contextual information specifically for the webpage and the task to the user, as shown at block 508. Accordingly, the toolbar may analyze data from the search engine service and may only display information relevant to the current webpage and the session of the user. The notification may contain the highest matching task type(s) for the user and the webpage. In the example above in which the user is looking at a webpage for a particular restaurant, the browser toolbar may present a notification that asks the user whether the user would like to plan an evening at the restaurant.

A determination is made at block 510 regarding whether the user selects (e.g., clicks on) the notification within a particular time period. If the user does not select the notification within the time period, the notification is dismissed, as shown at block 512. Alternatively, if the user clicks on the notification, detailed information and/or steps to complete a particular task (or multiple tasks) is displayed in a contextual information area, as shown at block 514. The information and/or steps may be presented in a variety of different manners, such as, for instance, a wing display area that is presented as a pop-out area of the browser toolbar.

The user has the option of simply consuming the displayed contextual information or to actively engage in the task process provided by the information. By way of example, the displayed information may contain a general description of the restaurant, the restaurant's price point, address, phone number, and a small map tile of the restaurant location. The information may also give the user steps to complete with the restaurant: reserve a table through a reservation service (e.g., the OPENTABLE reservation service), find directions to the restaurant, and read reviews about the restaurant. Each of these steps may include a link to a different webpage.

A determination is made at block 516 regarding whether the user selects an item (i.e., a particular piece of data or task step) in the contextual information area. If the user does not select anything, nothing happens as shown at block 518. However, if the user selects a particular item, the browser navigates to a particular URL associated with the selected item, as shown at block 520. The contextual information area, however, continues to be displayed by the browser toolbar, as shown at block 522. In some embodiments, the contextual display area may remain the same size after a selection, while in other embodiments, the contextual display area may shrink after a selection as some data may be removed from the contextual display area. For instance, the contextual display area could be configured to only show the remaining pieces of data not yet selected or the remaining steps to complete a particular task. The currently selected step or data piece may be highlighted to give the user feedback on the progress. The user can reopen the full view by simply clicking on the contextual display area. Continuing the example above in which the contextual display area presents some information (i.e., a general description of the restaurant, the restaurant's price point, address, phone number, and a small map tile of the restaurant location) and three steps to complete with the restaurant (i.e., reserve a table through a reservation service, find directions to the restaurant, and read reviews about the restaurant), suppose the user selects to read reviews. The user would be navigated to a webpage with reviews for the restaurant, and the contextual display area may be minimized to only show the three steps as icon representations while having the review icon highlighted as the currently active step.

As a user completes a step (e.g., read reviews about the restaurant), as shown at block 524, the contextual display area may provide an indication that the step has been completed, as shown at block 526. For instance, a check mark could be placed next to the icon for the step or the icon could be removed from the contextual display area. Continuing the restaurant example from above, a check mark could be placed on the read reviews icon after the user has accessed and read the restaurant reviews. The process of completing steps may be repeated until a determination is made that all steps have been completed, as shown at block 528. As user navigates to different webpages associated with the various steps, the contextual display area is persistently displayed by the browser toolbar to allow the user to view what steps have been completed and/or still need to be completed. At the completion of the scenario, the contextual display area may be closed, as shown at block 530. The browser toolbar may provide a way for the user to save the contextual information or the task flow for future uses. Additionally, if the user is interrupted before completing all tasks, the user may be given the option to save the current state so they can resume from that point at a later time.

As can be understood, embodiments of the present invention related to a browser toolbar providing presenting contextual data from a search engine service when a user is browsing a webpage. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method for a search engine service to provide contextual information to a browser toolbar, the method comprising:
receiving, from the browser toolbar on a user device, an indication of a URL of a webpage currently being viewed by a user of the user device;
determining an entity corresponding with the URL;
gathering relevant data regarding the entity from a search engine index; and
providing the relevant data regarding the entity to the browser toolbar on the user device for presenting at least a portion of the relevant data on the user device via the browser toolbar.

2. The method of claim 1, wherein the entity corresponding with the URL is determined by accessing an entity map identifying the entity as corresponding with the URL.

3. The method of claim 1, wherein the entity corresponding with the URL is determined by accessing data about the URL indexed in a search engine index.

4. The method of claim 1, wherein the method further comprises receiving session data from the browser toolbar, the session data including an identification of other URLs corresponding with additional webpages viewed by the user of the user device during a current browsing session.

5. The method of claim 4, wherein the entity is determined based on both the URL of the webpage currently being viewed by the user and the session data.

6. The method of claim 5, wherein the entity is determined based on both the URL of the webpage currently being viewed by the user and the session data in response to determining that the entity cannot be identified based on the URL alone.

7. The method of claim 1, wherein gathering the relevant data regarding the entity from the search engine index comprises gathering data of a particular type dependent on a classification type for the entity.

8. The method of claim 1, wherein the method also comprises gathering additional relevant data for the URL from the search engine index.

9. One or more computer storage media storing computer-useable instructions that, when used by one or more computing devices, cause the one or more computing devices to perform a method for presenting contextual data using a browser toolbar, the method comprising:
identifying a URL of a webpage currently being viewed by a user in a web browser;
providing an indication of the URL to a search engine service that identifies an entity corresponding with the URL and retrieves data regarding the entity;
receiving the data regarding the entity from the search engine service;
providing a contextual display area to display at least a portion of the data regarding the entity to the user, including a plurality of actions that include links to other webpages to perform the actions;
receiving a user selection of a first link corresponding with a first action; and
continuing to display the contextual display area when the web browser navigates to a webpage corresponding with the first link.

10. The one or more computer storage media of claim 9, wherein the method also includes:
tracking session data, the session data including an identification of other URLs corresponding with additional webpages viewed by the user of the user device during a current browsing session;
providing the session data to the search engine service that determines the entity corresponding with the URL based on both the URL of the webpage currently being viewed by the user and the session data.

11. The one or more computer storage media of claim 9, wherein the method further comprises:
receiving data regarding the URL from the search engine service; and
providing at least a portion of the data regarding the URL for display in the contextual display area.

12. The one or more computer storage media of claim 9, wherein providing the contextual display area to display at least a portion of the data regarding the entity to the user comprises:
detecting that the user is attempting to complete a task;
categorizing a type of task the user is attempting to complete; and
comparing the type of task the user is attempting to complete to the data regarding the entity received from the search engine service to select a portion of the data regarding the entity to display to the user.

13. The one or more computer storage media of claim 9, wherein providing the contextual display area to display at least a portion of the data regarding the entity to the user comprises:
providing a notification of contextual data for presentation to the user;
receiving a selection of the notification by the user; and
providing the contextual display area for display based on the selection of the notification by the user.

14. The one or more computer storage media of claim 9, wherein the method further comprises:
detecting that the user has completed the first action; and
providing an indication in the contextual display area that the first action has been completed.

15. The one or more computer storage media of claim 9, wherein the method further comprises removing some information from the contextual display area in response to receiving the user selection of the first link corresponding with the first action.

16. The one or more computer storage media of claim 9, wherein the method further comprises closing the contextual display area when the user has completed each of the actions.

17. One or more computer storage media storing a browser toolbar usable in web browser, the browser toolbar comprising:
a session tracking component that identifies URLs of webpages visited by a user during a current browsing session;
a search engine interface that communicates to a search engine service an identification of a URL of a webpage currently being displayed in the web browser and session data that identifies URLs of other webpages visited during the current browsing session, the search engine interface also receiving in return from the search engine relevant data regarding an entity corresponding with the webpage currently being displayed in the web browser;
a contextual data display component the displays at least a portion of the relevant data.

18. The one or more computer storage media of claim 17, wherein the contextual data display component displays a plurality of user-selectable items that link to additional webpages, and wherein the contextual data display component continues to display some of the relevant when a user selects an item to visit one of the additional webpages.

19. The one or more computer storage media of claim 17, wherein the contextual data display component heuristically selects information to display from the relevant data based on user interaction with the current browsing session.

20. The one or more computer storage media of claim 17, wherein the relevant data comprises a plurality of pieces of data with different classification types and the contextual data display component selects a portion of the pieces of data to display based on classification types of the data.
